(19) United States
(12) Patent Application Publication
(10) Pub. No.: US 2025/0231058 A1
(43) Pub. Date: Jul. 17, 2025

(54) METER TRANSMISSION UNIT MOUNTING DEVICE

(71) Applicant: Hubbell Incorporated, Shelton, CT (US)

(72) Inventors: Scott Ryan Venczel, Knoxville, TN (US); Zach Kane Timm, Athens, TN (US); Jacob Brett Murrell, Maryville, TN (US); John T. Polk, III, Townsend, TN (US); Kyle Edward Guthrie, Oklahoma City, OK (US)

(21) Appl. No.: 18/735,689

(22) Filed: Jun. 6, 2024

Related U.S. Application Data
(60) Provisional application No. 63/619,879, filed on Jan. 11, 2024.

(51) Int. Cl. G01F 15/14; G01F 15/18

(52) U.S. Cl. CPC G01F 15/14; G01F 15/18

(57) ABSTRACT

A utility enclosure includes a cover and a mounting unit. The cover can be positioned within an opening. The cover includes a cover body with a first surface and a second surface opposite to the first surface. An opening is formed in the second surface and includes an undercut. The mounting unit has a unit body and a connector that extends from the unit body and can be received within the opening. The connector includes a lip that can engage with the undercut when the connector is inserted into the opening with a snap fit.

### CROSS-REFERENCE TO RELATED APPLICATION

This application claims the benefit of U.S. Provisional Application No. 63/619,879, filed Jan. 11, 2024, the entire contents of which is incorporated herein by reference in its entirety.

### FIELD

The present disclosure relates to a mounting device. More particularly, the present disclosure relates to a mounting device that is selectively engageable to a meter transmission unit cover.

### BACKGROUND

Utility covers are used to enclose a volume that houses utility components (e.g., a meter transmission unit). The utility covers are designed to be secured in place with the utility component.

Utility covers may be constructed from a variety of materials including injection-molded materials. The resulting injection-molded cover may include standoffs or other protruding elements. Utility components may be connected to the cover (e.g., directly or indirectly) via the standoffs. This type of connection involves inserting fasteners into the standoffs, which can be cumbersome and difficult to remove.

### SUMMARY

Various embodiments of the present disclosure can overcome various of the aforementioned and other disadvantages associated with known mounting units and offer new advantages as well.

According to one aspect of various embodiments of the present disclosure there is provided a mounting unit for supporting a device (e.g., a meter transmission unit (MTU)) that is removably coupled to a cover.

According to one aspect of various examples of the present disclosure there is provided a mounting unit having a body and a connector extending from the body. The connector may engage an opening with a snap fit.

According to one aspect of various embodiments of the present disclosure there is provided a mounting unit having a connector that includes a lip which can engage with an undercut to couple the mounting unit in place.

According to one aspect of various embodiments of the present disclosure there is provided a cover with an opening for selectively receiving a mounting unit.

According to one aspect of various embodiments of the present disclosure there is provided a polymer cover that includes an opening with an undercut that can engage with a lip of a connector to form a snap-fit connection.

According to one aspect of various embodiments of the present disclosure there is provided a utility enclosure that includes a cover with an opening and a mounting unit that selectively connects to the cover within the opening.

According to one aspect of various embodiments of the present disclosure there is provided a utility enclosure that includes a mounting unit that selectively connects to an opening in a polymer cover.

According to another aspect of various embodiments of the present disclosure, there is provided a utility enclosure includes a cover and a mounting unit. The cover can be positioned within an opening. The cover includes a cover body with a first surface and a second surface opposite to the first surface. An opening is formed in the second surface and includes an undercut. The mounting unit has a unit body and a connector that extends from the unit body and can be received within the opening. The connector includes a lip that can engage with the undercut when the connector is inserted into the opening with a snap fit.

According to another aspect of various embodiments of the present disclosure, there is provided a utility enclosure includes a cover and a mounting unit. The cover can be positioned within an opening. The cover includes a cover body with a first surface and a second surface opposite to the first surface. An opening is formed in the second surface and includes mounting feature. The mounting unit can be at least partially received within the opening. The mounting unit includes a second mounting feature that can engage with the first mounting feature when the mounting unit is inserted into the opening with a snap fit. The mounting unit includes a first arm and a second arm each disposed outside of the opening. The first arm and the second arm can support a transmission unit.

According to another aspect of various embodiments of the present disclosure, there is provided a mounting unit that can support a transmission unit. The mounting unit includes a base and a mounting feature. The base has a support configured to support the transmission unit. The mounting feature includes a fixed end connected to the base and a free end that extends away from the base. The free end includes a lip. The mounting feature also includes a gap that extends from the free end toward the fixed end and divides the mounting feature into a first section and a second section. The first and second sections can flex toward one another about the gap.

According to another aspect of various embodiments of the present disclosure, there is provided a method of assembling a utility enclosure, the method including: connecting a transmission unit to a mounting unit, wherein the mounting unit has a first portion for supporting the transmission unit and a second portion having a lip; aligning the mounting unit with an opening in a cover; inserting the second portion into the opening; and connecting the mounting unit to the cover by snap-fitting the lip within the opening.

The disclosure herein should become evident to a person of ordinary skill in the art given the following enabling description and drawings. The drawings are for illustration purposes only and are not drawn to scale unless otherwise indicated. The drawings are not intended to limit the scope of the invention. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred embodiments and reference to the accompany drawing wherein:

FIG. 1 shows top perspective view of a cover for use with a meter transmission unit.

FIG. 2 shows a bottom perspective view of the cover of FIG. 1.

FIG. 3 shows a bottom view of the cover of FIG. 1.

FIG. 4 shows a first cross-sectional view of the cover of FIG. 1, viewed along section 4-4.

FIG. 5 shows a side view of the cover of FIG. 4

FIG. 6 shows a perspective view of a holder for a meter transmission unit.

FIG. 7 shows a cross-sectional view of the holder of FIG. 6, viewed along section 7-7.

FIG. 8 shows a bottom perspective view of a first assembly step for the holder of FIG. 6 to connect to the cover of FIG. 1.

FIG. 9 shows a cross-sectional view of a second assembly step for the holder of FIG. 6 to connect to the cover of FIG. 1.

FIG. 10 is a cross-sectional view of a third assembly step for the holder of FIG. 6 to connect to the cover of FIG. 1.

FIG. 11 is a bottom perspective view of the third assembly step with the holder of FIG. 6 connected to the cover of FIG. 1.

FIG. 12 is an exploded view of an enclosure that includes the cover of FIG. 1 secured to a flange using a fastener.

### DETAILED DESCRIPTION

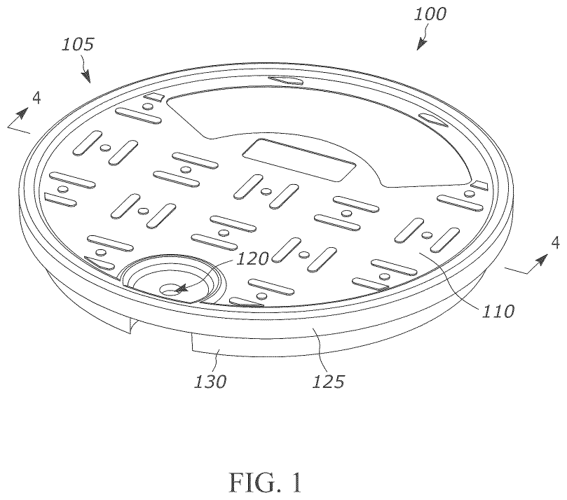

FIGS. 1 to 5 illustrate a cover 100 for use with a utility. For example, the cover 100 may be used with water meters, although the cover 100 may be used with any type of utility (e.g., gas).

In some forms, the cover 100 may be constructed from a polymer (e.g., polypropylene). This material may permit the cover 100 to be easily molded (e.g., injection molded) and relatively light weight while being sufficiently strong. However, in other examples, the cover 100 may be constructed from another material (e.g., concrete, aluminum, etc.).

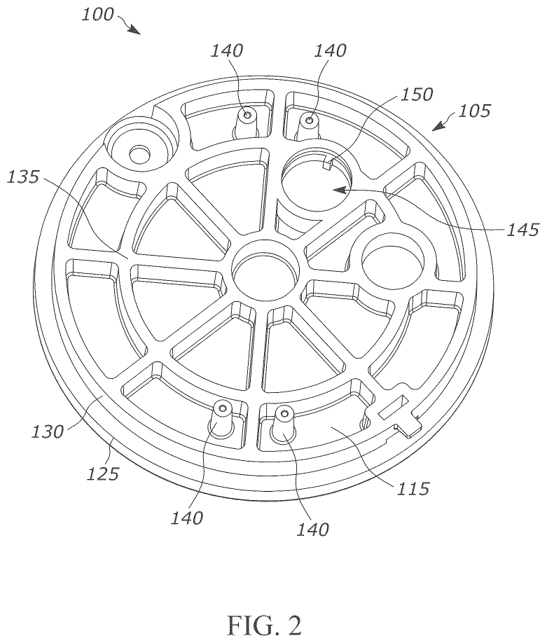

As shown in FIGS. 1 and 2, the cover 100 includes a body 105 with a top surface 110 and a bottom surface 115 opposite to the top surface 110. The top surface 110 may be exposed when the cover 100 is secured.

The cover 100 may include an aperture 120 that extends through the body 105 between the top surface 110 and the bottom surface 115. In the illustrated example, the aperture 120 may be circular (although other shapes may be used). An opening to the aperture 120 may also be recessed in the top surface 110. As described below, this may enable a fastener to sit substantially flush with the top surface 110 when connected to the cover 100.

The body 105 may include a first outer perimeter 125 and a second outer perimeter 130 that is smaller than the first outer perimeter 125. The outer perimeters 125, 130 may be formed as stepped surfaces. The first outer perimeter 125 may be proximate to the top surface 110 and the second outer perimeter 130 may be proximate to the bottom surface 115. The different perimeters 125, 130 may permit the body 105 to be seated in an opening (not shown) without falling through.

As shown in FIG. 2, the bottom surface 115 of the body 105 may include a web-shaped structure 135 that radiates outwardly from a middle of the bottom surface 115. In some forms, standoffs 140 may be between the web-shaped structure 135 proximate to the second outer perimeter 130. The standoffs 140 may be frustoconical or cylindrical structures that extend away from the bottom surface 115 and include a central opening. Other examples of the standoffs 140 may be any other shape.

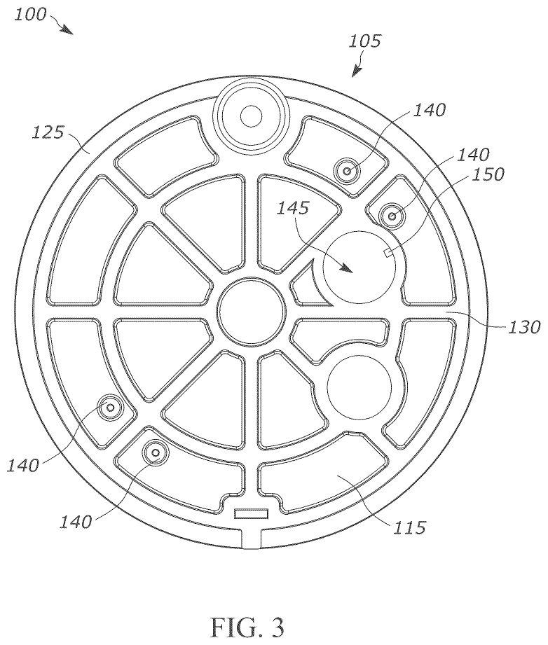

As shown in FIGS. 2 and 3, an opening 145 may be disposed in the bottom surface 115 between the web-shaped structure. In the illustrated example, the opening 145 is substantially circular and is disposed non-concentrically with a center of the bottom surface 115. However, other examples may include openings 145 having different shapes and/or openings 145 positioned at different locations on the bottom surface 115.

With continued reference to FIGS. 2 and 3, a projection 150 may be formed within the opening 145. The illustrated projection 150 may be substantially rectangular, although it may be formed as any other shape (e.g., cylindrical, triangular, etc.).

In some forms, the projection 150 may be formed at a bottom of the opening 145 and may extend toward a center of the opening 145. In other words, the projection 150 may be at least partially recessed relative to the ingress of the opening 145. Additionally, the width of the projection 150 may be less than the width (e.g., radius) of the opening 145 so that the projection 150 does not extend entirely to the middle of the opening 145. The projection 150 may be disposed at any angular position of the opening 145.

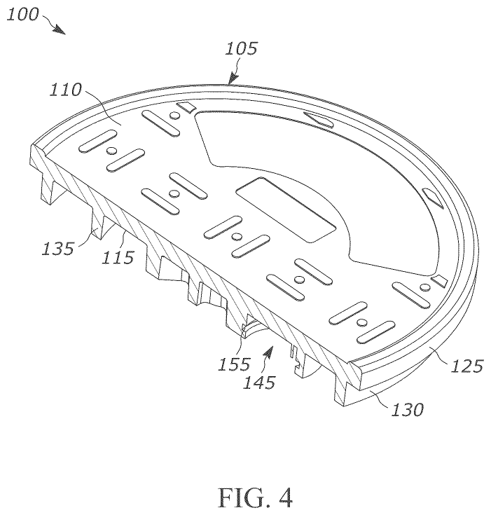

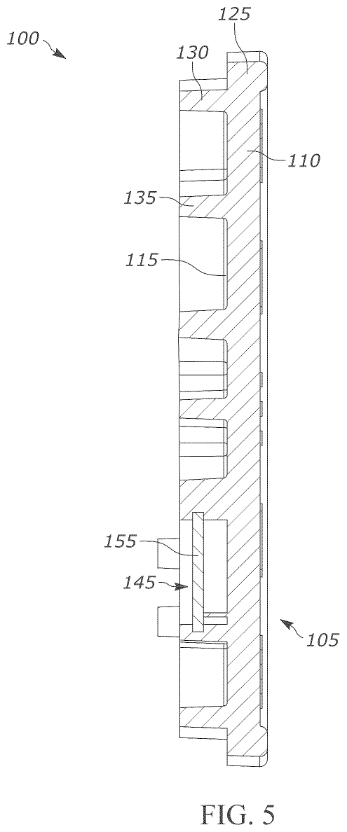

As shown in FIGS. 4 and 5, the opening 145 may include a groove 155. The illustrated example includes both a projection 150 and a groove 155, although other examples may include one or the other.

In the illustrated example, the groove 155 may be formed as an undercut and is recessed relative to an ingress of the opening 145. For example, the groove 155 may be disposed proximate to the ingress, although other examples of the groove 155 may be disposed along any depth of the opening 145. The undercut may be formed with collapsible core tooling in the injection molding process.

In some forms, the groove 155 extends around the entire perimeter of the opening 145 (e.g., 360 degrees). While in other examples, the groove 155 may extend around only a portion of the opening 145.

The groove 155 may have a substantially rectangular shape when viewed in cross section (see e.g., FIG. 5). For example, adjacent walls of the groove 155 may be substantially perpendicular to one another (e.g., not curved or oblique), although other shapes may also be used.

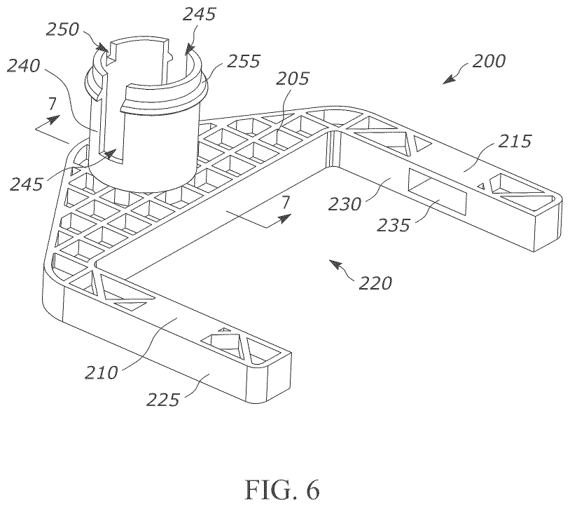

FIG. 6 illustrates a bracket 200 which may be used to support a meter transmission unit (MTU—not shown). The bracket 200 may be constructed from a plastic material (e.g., via injection molding), although any other material or process may be used (e.g., the bracket 200 may be constructed from a metal like aluminum).

The bracket 200 includes a base 205 with a first arm 210 and a second arm 215 that is spaced apart from the first arm 210. The illustrated base 205 may have a substantially U-shape or C-shape where the arms 210, 215 are disposed on either side of the base 205 and extend in the same direction (e.g., the arms 210, 215 may be cantilever members). The arms 210, 215 may extend so that they are substantially parallel to one another. However, other examples of the base 205 may include the arms 210, 215 at different locations and/or orientations. In still other examples, there may be a different number of arms (e.g., one, three, etc.).

In some forms, a mounting opening 220 may be formed in the space between the first and second arms 210, 215. Each arm 210, 215 may include an outer surface 225 and an opposing inner surface 230. The inner surface 230 of each arm 210, 215 may face one another and form at least a portion of the boundary of the mounting opening 220.

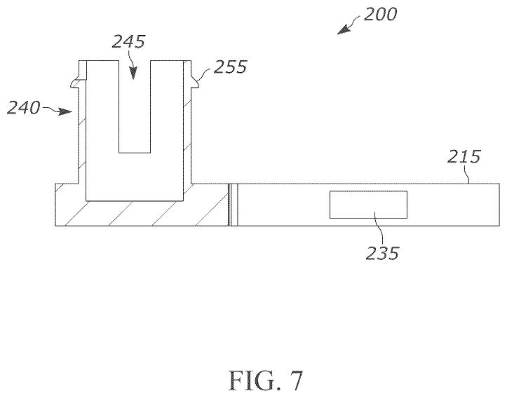

As shown in FIGS. 6 and 7, an aperture 235 may be formed into the inner surface 230 of at least one of the arms 210, 215. The illustrated aperture 235 includes a rectangular opening, although any shape (e.g., circular, elliptical, triangular, rounded-rectangular, etc.) may be used. Each arm 210, 215 may include an aperture 235 and the two apertures 235 may be aligned with one another across the mounting opening 220 (e.g., each aperture 235 is disposed the same distance along the length of the inner surface 230).

In certain forms, each aperture 235 may be formed in the middle of the respective cantilever arm 210, 215. However, in other examples, the apertures 235 may be formed closer to or further from a free end of the respective arm 210, 215.

With continued reference to FIGS. 6 and 7, a connector 240 may extend from the base 205. The illustrated connector 240 may be formed as a partially cylindrical member, although other examples of the connector 240 may be a different shape (e.g., elliptical, rectangular, etc.).

In some forms, the connector 240 extends away from the body 205 in a direction substantially perpendicular to the arms 210, 215. For example, the connector 240 and the arms 210, 215 may be disposed in different planes.

In some forms, the connector 240 may not form a complete perimeter. For example, at least one gap 245 (e.g., two shown) may be formed in the connector 240. The gaps 245 may have an elongated shape (e.g., extend along the length of the and have a substantially rectangular shape, although other shapes and sizes of the gap 245 may be used. The illustrated gaps 245 may be disposed on opposite sides of the connector 240 (e.g., 180 degrees apart), although other circumferential locations may also be used.

In certain forms, the connector 240 may include a notch 250 (see e.g., FIG. 6). The illustrated notch 250 may have a length less than the length of the gaps 245, although the notch 250 may be formed with any length. The notch 250 may be formed at a free end of the connector 240. The notch 250 may be spaced apart from both of the gaps 245 (e.g., 90 degrees apart), although any spacing may be used. The notch 250 may form an additional discontinuity in the perimeter of the connector 240.

In one form, the connector 240 may be substantially hollow. A top of the connector 240 (e.g., proximate to the notch 250) may be open. Portions of the connector 240 between the

In some forms, the connection 240 may include a lip 255 that may extend around at least a portion of the perimeter of the connector 240. For example, the lip 255 may not span the gaps 245, and thus may be formed as discrete sections. The illustrated example may also include the lip 255 disposed below the notch 250 so that the length of the notch 250 does not intersect with the

As shown in FIG. 7, the lip 255 may have a substantially triangular shape when viewed in cross-section. For example, the lip 255 may be inclined relative to the outer surface connector 240 so that a width of the lip 255 increases closer to the base 205.

In use, the bracket 200 may be connected to the cover 100 to enable the MTU to be connected to the cover 100. This connection is described in more detail below.

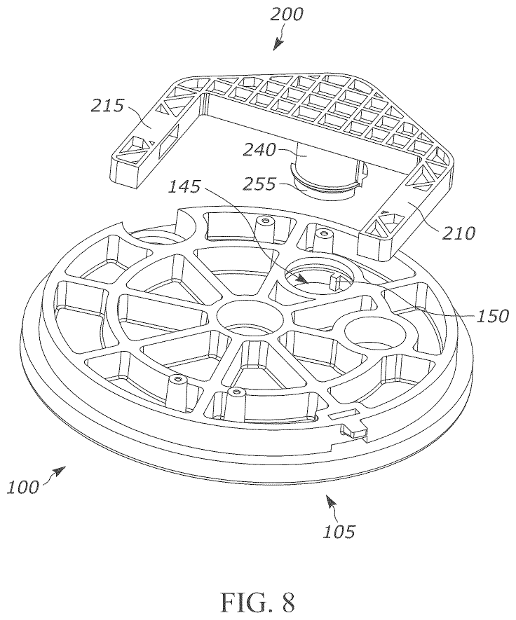

FIG. 8 illustrates a first step in connecting the bracket 200 to the cover 100. The bracket 200 may be aligned with the opening 145 on the bottom surface 115 of the cover 100. Specifically, the connector 240 may be oriented proximate to the opening 145 with the notch 250 aligned with the projection 150 in the opening 145.

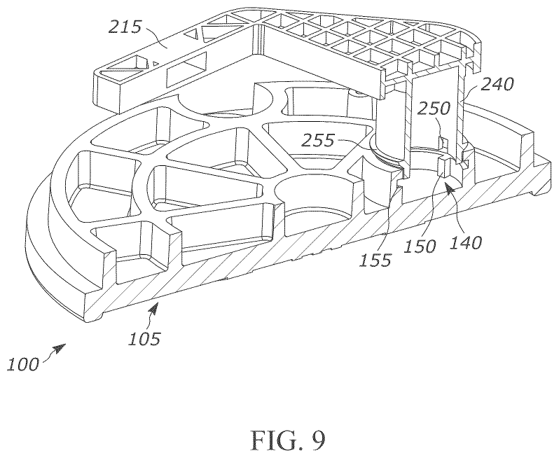

FIG. 9 illustrates a second step in connecting the bracket 200 to the cover 100. The bracket 200 is moved toward the opening 145 with the notch 250 continued to be aligned with the projection 150. As the connector 240 approaches the cover 100, the lip 255 may contact the perimeter around the ingress of the opening 145. The lip 255 may be oriented so that the portion with the smaller width contacts the perimeter of the opening 145 before the portion with the larger width (e.g., because of the orientation of the inclination).

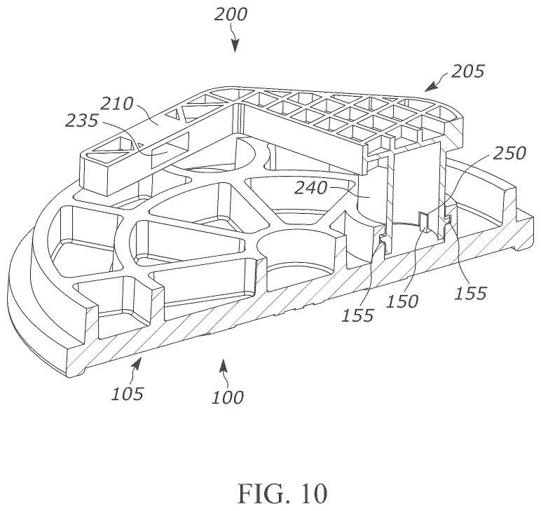

FIG. 10 illustrates a third step in connecting the bracket 200 to the cover 100. The connector 240 is moved further into the opening 145 so that the lip 255 passes entirely through the ingress of the opening 145.

In some forms, the gaps 245 of the connector 240 may permit the connector to flex as it is moved into the opening 145. For example, the outermost perimeter of the connector 240 (e.g., at the lip 255) may be greater than the perimeter of the opening 145. The flexion of the connector 240 about the gaps 245 may temporarily reduce the outer perimeter of the connector 240 and enable it to pass through the opening 145.

In certain forms, the inclination of the lip 255 may also assist in permitting the larger width of the lip 255 to pass through the ingress of the opening 145. For example, the shape of the lip 255 may act as a ramp that allows the lip 255 to slide through the opening 145. The slope of the lip 255 may assist in flexing the connector 240 (e.g., without additional intervention) as the connector 240 moves through the opening 145. The combination of the connector 240 flexing and the inclination of the lip 255 may permit a smooth insertion of the connector 240.

The connector 240 may remain in the flexed position until the lip 255 reaches the groove 155. The outer width of the groove 155 may be at least as large as the outer width of the lip 255. The lip 255 may fit into the groove 155 and the connector 240 may return to a neutral position.

In some forms, this connection may define a snap-fit connection where the lip 255 is interlocked with the groove 155 when the connector 240 is fully inserted into the opening 145. For example, the bias of the flexed connector 240 may automatically return toward its neutral position when the lip 255 reaches the groove 155 and the undercut of the groove 155 may limit movement of the connector 240 out of the opening 145 (e.g., a user may need to physically compress the connector 240 to remove the lip 255 from the groove 155).

In some forms, notch 250 may fit around the projection 150 when the connector 240 is fully inserted into the opening 240. The notch 250 may be sized substantially the same as the projection 150 so that the edges of the notch 250 are substantially close to the walls of the projection 150. In use, the connector 240 may be limited from rotating about the opening 240 by the engagement between the notch 250 and the projection 150. This may assist in maintaining the connector 240 in a desired orientation. For example, the connector 240 may be maintain within a projection of the area of the cover 100. This may enable the cover 100, with the coupled connector 240, to be more easily removed.

In other examples, the projection 150 may be smaller compared to the notch 250 or the projection 150 may be omitted. This may permit the connector 240 to at least partially rotate about the opening 240. In this example, the lip 255 may move within the groove 155 to enable the bracket 200 to rotate.

When connected, no additional fasteners or retainers may be needed to secure the bracket 200 to the cover 100. The bracket 200 may be easily connectable and disconnectable with a simple motion (e.g., squeezing the connector 240) so that the bracket 200 may be repeatably connected is disconnected from the cover 100. This may assist a user in inspecting the MTU.

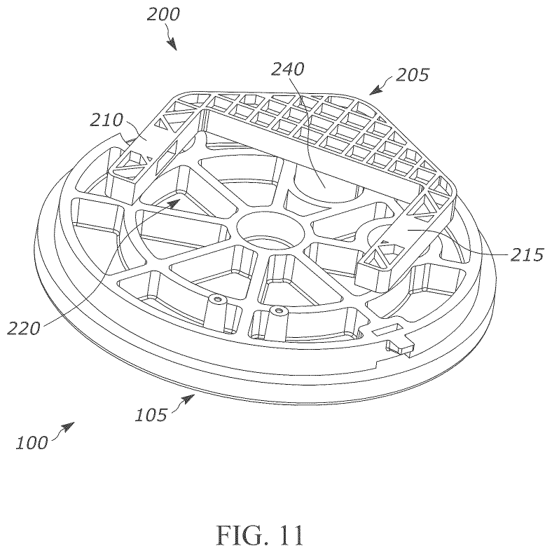

As shown in FIG. 11, the fully coupled connector 240 is oriented so that the arms 215, 220 extend over the surface of the cover 100. In other words, the illustrated arms 215, 220 are fully contained within the area of the cover 100. This may enable the MTU to also be positioned within the area of the cover 100.

In other examples (not shown), the opening 145 and the connector 240 may be reversed. In other words, the bracket 200 may include an opening with an undercut and the cover 100 may include a connector with a lip. The connection between these two elements may be substantially the same (e.g., via a snap fit) as with the illustrated example described above.

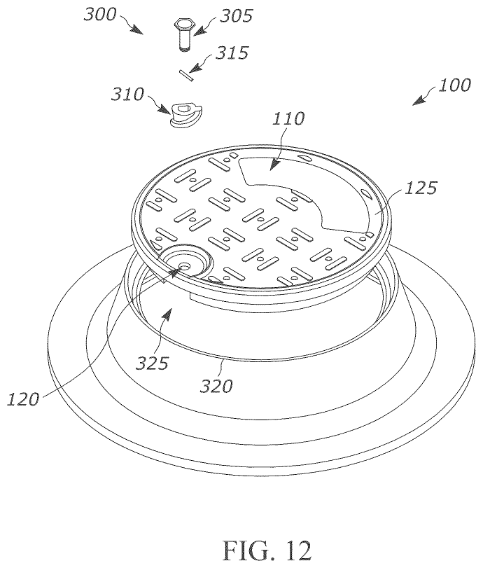

As shown in FIG. 12, a fastener 300 may be used to secure the cover 100 in an opening 50. The fastener 300 may include a bolt 305 and a worm gear 310 that are connected together via a pin 315. The fastener 300 may be used to secure a utility cover to a ledge 320 around the opening 325 to limit unwanted access.

In some forms, at least a portion of the fastener 300 may be constructed using a non-metallic material (e.g., nylon, polypropylene, etc.), which may reduce manufacturing costs. For example, the non-metallic materials may be cheaper than metals and/or may require less machining to meet specified tolerances.

The forces necessary for the fastener 300 to retain the cover 100 may be achievable with non-metallic materials. Additionally, workers may inspect utilities enclosed by the cover 100 infrequently. In other words, workers are not frequently tightening and untightening the fastener 300. Even if a non-metallic fastener 300 has a lower number of cycles until failure, the infrequency at which the cycles occur and the relatively inexpensive cost to replace the fastener 300 may still allow for the use of non-metallic materials.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

1. A utility enclosure comprising:
a cover configured to be positioned within an opening, the cover including,
a cover body having a first surface and a second surface opposite to the first surface, and
an opening formed in the second surface and including an undercut; and
a mounting unit having a unit body and a connector extending from the unit body and configured to be received within the opening, the connector including a lip that is configured to engage with the undercut when the connector is inserted into the opening with a snap fit.

2. The utility enclosure of claim 1, further comprising a projection disposed within the opening and a notch formed in the connector, wherein the notch is configured to receive the projection and limit relative rotation between the cover and the mounting unit when the connector is inserted into the opening.

3. The utility enclosure of claim 2, wherein the projection is disposed at a greater depth with the opening than the undercut.

4. (canceled)

5. The utility enclosure of claim 1, wherein the connector includes a substantially cylindrical shape with a first section, a second section, and a gap formed between the first and second sections, wherein the first and second sections are configured to flex toward one another about the gap when the connector is received within the opening.

6. (canceled)

7. The utility enclosure of claim 1, wherein the cover is constructed from a polymer material.

8. The utility enclosure of claim 1, wherein the undercut is formed as a groove in a wall of the opening and extends around the entire perimeter of the opening.

9. The utility enclosure of claim 1, wherein the mounting unit includes a first arm and a second arm spaced apart from the first arm, the first arm and the second arm each extend from the unit body in the same direction, the first arm includes a first inner surface that faces the second arm and the second arm includes a second inner surface that faces the first arm, each of the first inner surface and the second inner surface includes a mounting aperture configured to receive an electrical device.

10.-13. (canceled)

14. A utility enclosure comprising:
a cover configured to be positioned within an opening, the cover including,
a cover body having a first surface and a second surface opposite to the first surface, and
an opening formed in the second surface and including first mounting feature; and
a mounting unit configured to be at least partially received within the opening, the mounting unit including a second mounting feature that is configured to engage with the first mounting feature when the mounting unit is inserted into the opening with a snap fit, wherein the mounting unit includes a first arm and a second arm each disposed outside of the opening, wherein the first arm and the second arm are configured to support a transmission unit.

15. The utility enclosure of claim 14, wherein the first mounting feature is an undercut disposed within the opening, the first mounting feature extending entirely around a perimeter of the opening.

16. The utility enclosure of claim 14, wherein the second mounting feature is a lip having a first end and a second end that is wider than the first end, wherein the first end is configured to be inserted into the opening before the second end.

17. The utility enclosure of claim 14, further comprising a projection disposed within the opening and a notch formed in the mounting unit, wherein the notch is configured to receive the projection and limit relative rotation between the cover and the mounting unit when the mounting unit is inserted into the opening.

18. The utility enclosure of claim 14, wherein the cover is constructed from a polymer material.

19. The utility enclosure of claim 14, wherein the first arm includes a first inner surface that faces the second arm and the second arm includes a second inner surface that faces the first arm, wherein the first inner surface includes a first mounting opening and the second inner surface includes a second mounting opening, the first mounting opening and the second mounting opening configured to support the transmission unit.

20. (canceled)

21. (canceled)

22. The utility enclosure of claim 14, wherein the mounting unit includes a connector that includes the second mounting feature, the connector includes a substantially cylindrical shape with a first section, a second section, and a gap formed between the first and second sections, wherein the first and second sections are configured to flex toward one another about the gap when the connector is received within the opening.

23. (canceled)

24. (canceled)

25. A method of assembling a utility enclosure, the method comprising:
connecting a transmission unit to a mounting unit, wherein the mounting unit has a first portion for supporting the transmission unit and a second portion having a lip;
aligning the mounting unit with an opening in a cover;
inserting the second portion into the opening; and
connecting the mounting unit to the cover by snap-fitting the lip within the opening.

26. The method of claim 25, wherein the opening includes a projection and the second portion includes a notch, wherein the method further includes orienting the notch to align with the projection and receiving the projection within the notch when the second portion is inserted into the opening.

27. The method of claim 25, further comprising removing the mounting unit from the cover by squeezing the second portion, wherein the second portion includes a substantially cylindrical shape with a first section, a second section, and a gap formed between the first and second sections, wherein the first and second sections are configured to flex toward one another about the gap.

28. (canceled)

29. The method of claim 25, wherein the lip has a first end and a second end that is wider than the first end, further comprising inserting the first end into the opening before the second end.

30. The method of claim 25, wherein the opening includes an undercut that extends around the perimeter of the opening.

31. The method of claim 25, wherein the cover is constructed from a polymer material.

32.-38. (canceled)
